(19) United States
(12) Patent Application Publication
(10) Pub. No.: US 2013/0007680 A1
(43) Pub. Date: Jan. 3, 2013

(54) Coverage Based Pairwise Test Set Generation for Verification of Electronic Designs

(76) Inventors: SUDHIR D. KADKADE, LAKE OSWEGO, OR (US); ALEXANDER MATTHEW LYONS, LAKE OSWEGO, OR (US)

(21) Appl. No.: 13/363,355

(22) Filed: Jan. 31, 2012

Related U.S. Application Data
(60) Provisional application No. 61/495,799, filed on Jun. 10, 2011.

(51) Int. Cl. G06F 17/50

(52) U.S. Cl. 716/107

(57) ABSTRACT

With various implementations of the invention, test sequences are generated using a pairwise methodology. The generated test sequences are checked using a constraint solver to determine if the test sequences satisfy a set of constraints. In some implementations, the uncovered pairs for a particular input are checked using the constraint solver to determine if any pairs violate the constraints. Any pairs found to violate the constraints can be excluded from the test set. With some implementations, the uncovered pairs are sorted such that the sum of every three consecutive elements is odd.

### FIELD

The present application is directed towards the verification of electronic designs.

More specifically, various implementations are applicable to generating test sets using a pairwise methodology, which satisfy specified verification criteria.

### BACKGROUND

Electronic devices are used in a variety of products, from personal computers to automobiles to toys. There are various different types of electronic devices, such as, for example, an integrated circuit. Furthermore, as those of skill in the art will appreciate, electronic devices can be connected, to form other electronic devices or systems. The designing and fabricating of electronic devices typically involves many steps, sometimes referred to as the “design flow.” The particular steps of a design flow often are dependent upon the type of electronic device, its complexity, the design team, and the fabricator that will manufacture the device.

Several steps are common to most design flows. Initially, the specification for a new design is expressed, often in an abstract form and then transformed into lower and lower abstraction levels until the design is ultimately ready for manufacture. The process of transforming the design from one level of abstraction to another is referred to as synthesis. At several stages of the design flow, for example, after each synthesis process, the design is verified. Verification aids in the discovery of errors in the design, and allows the designers and engineers to correct or otherwise improve the design. The various synthesis and verification processes are facilitated by electronic design automation (EDA) tools.

As those of ordinary skill in the art will appreciate, the synthesis and verification processes applied to modern designs are quite complex and include many different steps. An illustrative design flow, for an integrated circuit, for example, can start with a specification for the integrated circuit being expressed in a high-level programming language, such as, for example, C⁺⁺. This level of abstraction is often referred to as the algorithmic level. At this abstraction level, the functionality of the design is described in terms of the functional behavior applied to specified inputs to generate outputs. The design will then be synthesized into a lower level of abstraction, typically, the logic level of abstraction. At this level of abstraction, the design is expressed in a hardware description language (HDL) such as Verilog, where the circuit is described in terms of both the exchange of signals between hardware registers and the logical operations that are performed on those signals. At this stage, verification is often performed to confirm the functional behavior of the design, i.e. that the logical design conforms to the algorithmic specification.

After the logical design is verified, it is synthesized into a device design. The device design, which is typically in the form of a schematic or netlist, describes the specific electronic components (such as transistors, resistors, and capacitors) that will be used in the circuit, along with their interconnections. This device design generally corresponds to the level of representation displayed in conventional circuit diagrams. Verification is again performed at this stage in order to confirm that the device design conforms to the logical design, and as a result, the algorithmic specification.

Once the components and their interconnections are established, as represented by the device design, the design is again synthesized, this time into a physical design that describes specific geometric elements. The geometric elements define the shapes that will be created in various layers of material to manufacture the circuit. This type of design often is referred to as a “layout” design. The layout design is then used as a template to manufacture the integrated circuit. Verification is again performed, to ensure that the layout design conforms to the device design.

Although there are different methods of performing verification, this invention is directed towards verification processes that “exercise” a design by applying input to the design and capturing the output resulting from application of the input. The applied input is often referred to as an input sequence. The captured output then is compared to the output the design should have produced according to the input sequence and the specification. Various technologies exist for exercising a design, for example, the response (i.e. the output) of the design to the input sequence, may be simulated. In some cases the output may be captured from an emulator, emulating the design with the input sequence as stimulus for the emulation. A prototype may also be used to generate the output. Those of ordinary skill in the art will appreciate that combinations of simulation, emulation, and prototyping could be used during verification and that various combinations of technologies can be employed to implement a verification system as described here.

Verification typically consists of applying multiple input sequences, referred to as the test set and capturing each resulting output, referred to as the output set. The individual outputs from the output set then are compared to the corresponding expected outputs. There are many ways to generate test sets. For example, directed tests, that is, where the input sequences are directly specified by a designer can be employed. Random combinations of inputs can also be selected and used to form input sequences. Additionally, a technique known as pairwise test set generation is often used. This approach focuses on covering all possible “pairs” of input combinations, rather than all possible combinations of inputs. Various pairwise test generation algorithms exist, such as, for example, the algorithm detailed in U.S. patent application Ser. No. 5,542,043, entitled “Method and System for Automatically Generating Efficient Test Case for Systems Having Interacting Elements” and issued on Jul. 30, 1996, which application is incorporated entirely herein by reference. Another pairwise test generation approach is detailed in The AETG System: An Approach to Testing Based on Combinatorial Design, by David M. Cohen et al., IEEE Transactions on Software Engineering, Vol. 23, No. 7, July 1997, which article is incorporated entirely herein by reference.

Although, ideally one would generate a test set that corresponds to all possible input combinations. The set of all possible input sequences to a modern electronic design is so large, that it is not computationally feasible to exhaustively test the design in this manner. As a result, another approach to generating input sequences for verification, referred to as coverage-based verification is often used.

With a coverage-based verification process, constraints on the set of all possible inputs are specified, and then input sequences that satisfy these constraints are generated. More specifically, the potential inputs that may be selected to form an input sequence from are restricted by using constraints. Then input sequences are generated from the remaining, unrestricted, inputs. Typically, inputs, input values, and combinations of inputs or input values that are required to exercise selected portions of the design's functionality are identified. Constraints then are written based on these identified inputs and input values. The set of constraints is often referred to as a coverage model. Verification progress then is measured by achieving the coverage described by the coverage model. More specifically, an acceptable level of verification is selected where input sequences corresponding to some portion of the coverage model are generated and included in the test set during verification. As the coverage model is often based on key features and functions of the design, it is often desirable that input sequences which exercise the entire coverage model be generated.

Conventional pairwise test generation systems and techniques do not allow for adequate input-constraints to be used. As many modern electronic devise include more features than customers can use at one time and different operating modes include different subsets of the overall feature set, many of the “theoretically” possible combinations of inputs are not actually possible. More specifically, many of the potential input combination are not inputs that need to be tested and verified as they are not inputs combinations that the device will encounter when used. Additionally, many of these input combination, as they are not intended input combination for the device, may produce errors in the verification, which the engineer will need to filter through when looking for actual design failure errors. As such, generating pairwise tests without considering input constraints often produces test sets that are not usable.

### SUMMARY

Aspects of the disclosed technology provide for the determination of a test set that satisfies a coverage model using a pairwise test set generation methodology.

With various implementations of the invention, test sequences are generated using a pairwise methodology. The generated test sequences are checked using a constraint solver to determine if the test sequences satisfy a set of constraints. In some implementations, the uncovered pairs for a particular input are checked using the constraint solver to determine if any pairs violate the constraints. Any pairs found to violate the constraints can be excluded from the test set. With some implementations, the uncovered pairs are sorted such that the sum of every three consecutive elements is odd.

These and additional implementations of invention will be further understood from the following detailed disclosure of illustrative embodiments.

### BRIEF DESCRIPTION OF THE DRAWINGS

The present invention will be described by way of illustrative implementations shown in the accompanying drawings in which like references denote similar elements, and in which:

FIG. 1 illustrates a computing device.

FIG. 2 illustrates a verification platform.

FIG. 3 illustrates a test set generation module.

FIG. 4 illustrates a method of generating a test set.

### DETAILED DESCRIPTION

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “generate” to describe the disclosed implementations. Such terms are often high-level abstractions of the actual operations that are performed. The actual operations that correspond to these terms will often vary depending on the particular implementation.

### Illustrative Operating Environment

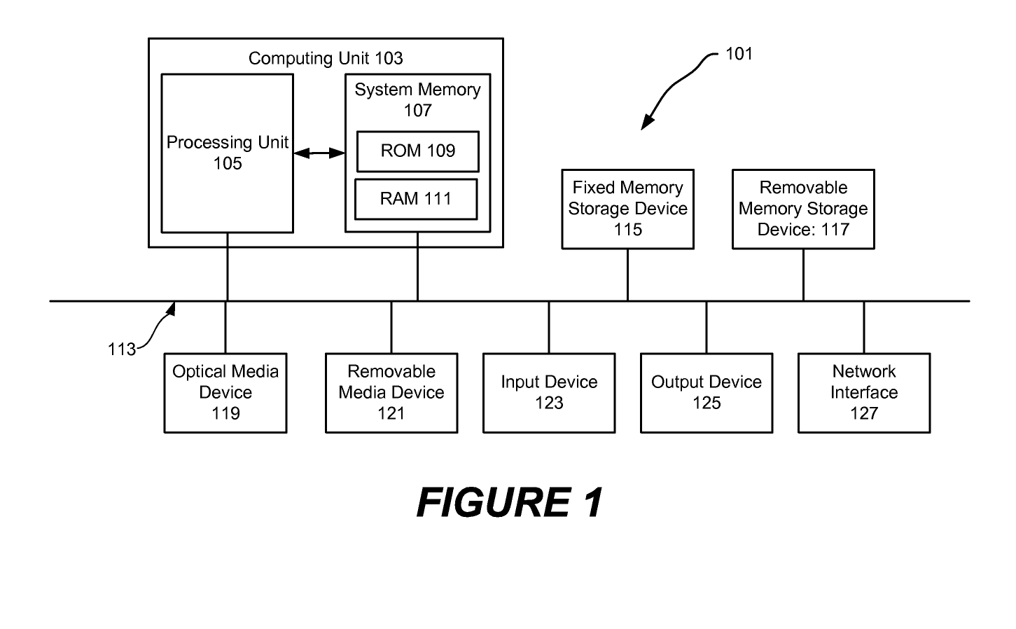

As the techniques of the present invention may be implemented using computer executable instructions, the components and operation of a programmable computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (“ROM”) 109 and a random access memory (“RAM”) 111. As will be appreciated by those of ordinary skill in the art, both the ROM 109 and the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

As stated above, various embodiments of the invention may be implemented using a programmable computer system executing software instructions, a computer readable medium having computer-executable software instructions stored thereon, or some combination thereof. Particularly, these software instructions may be stored on one or more computer readable media or devices, such as, for example, the system memory 107, or an optical disk for use in the optical media device 119. As those of ordinary skill in the art will appreciate, software instructions stored in the manner described herein are inherently non-transitory in nature. More specifically, the software instructions are available for execution by the computer system 101, as opposed to being transmitted to the computer system via a carrier wave or some other transitory signal.

### Coverage Based Verification

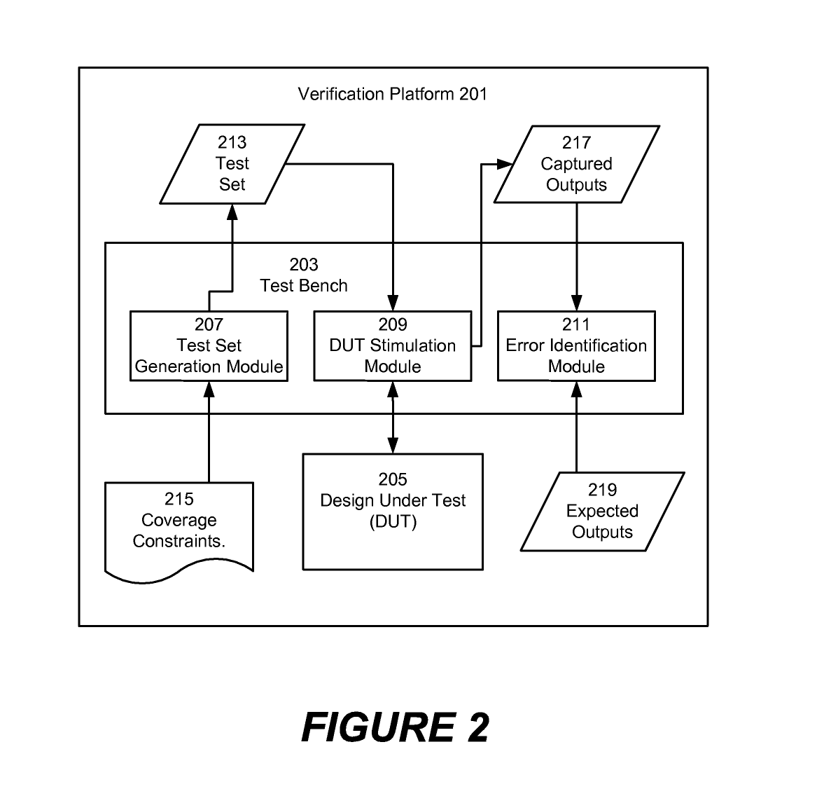

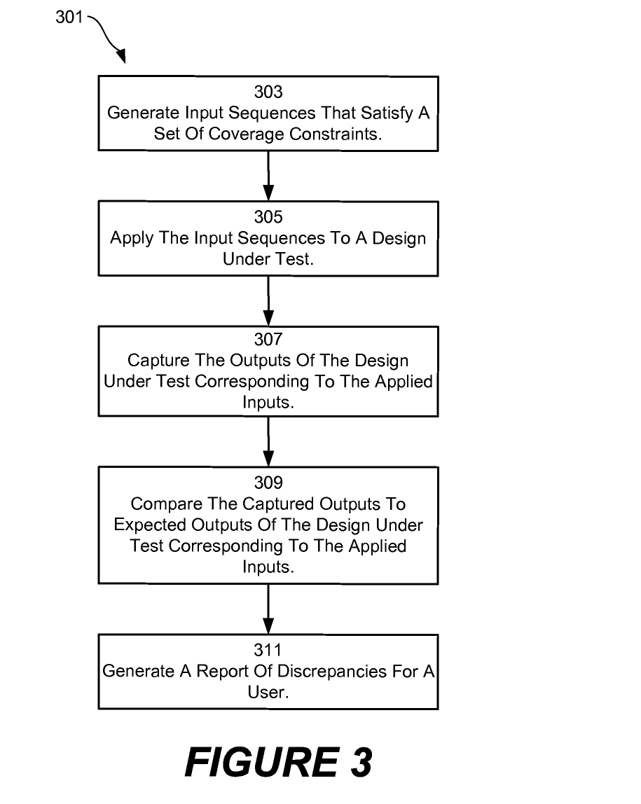

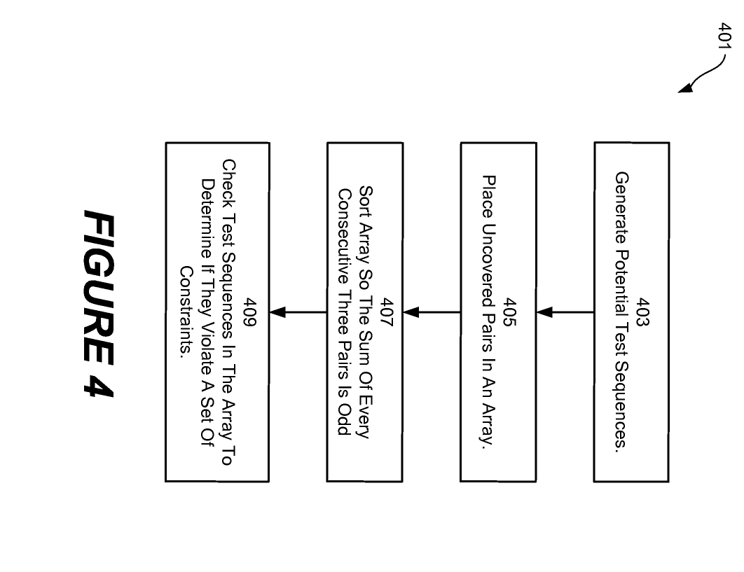

As detailed above, various implementations of the invention provide methods and apparatuses for generating a test set based upon a pairwise testing methodology that satisfies a set of constraints. FIGS. 2 and 3 illustrate a verification platform 201 and a method 301 of performing verification that may be provided by various implementations of the present invention.

As can be seen from FIG. 2, the verification platform 201 includes a test bench 203 and a design under test (DUT) 205. With various instances of the invention, the DUT 205 will be implemented by an electronic design simulator, such as, for example, the Questa simulator available from Mentor Graphics Corporation of Wilsonville, Oreg. In some instances, the DUT 205 will be implemented by an electronic design emulator, such as, for example, the Veloce emulator available from Mentor Graphics Corporation of Wilsonville, Oreg. In various instances, the DUT 205 will be implemented by a prototype of the electronic design for which the DUT 205 represents. Still, with some implementations of the invention, combinations of these different embodiments may be used. For the balance of this disclosure however, it is assumed for purposes of clarity that the DUT 205 is implemented in a simulator.

The test bench 203 includes a test set generation module 207 configured to derive a set of input sequences (i.e. the test set 213) for the DUT 205 that satisfy a set of coverage constraints 215. The derivation of input sequences by the test set generation module 207 will be discussed in greater detail below. The test bench 203 further includes a DUT stimulation module 209 configured to apply the input sequences from the test set 213 to the DUT 205. The DUT stimulation module 209 is also configured to capture the responses of the DUT 205 as it is simulated with the test set 213 as input. These captured responses are referred to as the captured outputs 217. Additionally, an error identification module 211 is provided, which is configured to compare the captured outputs 217 to a set of expected outputs 219. The error identification module 211 is further configured to identify any discrepancies in the comparison and report them as potential errors in the DUT 205.

As stated, FIG. 3 shows the method 301, which may be applied using the verification platform described above. As can be seen from this figure, the method 301 includes an operation 303 for generating the test set 213, that is, for generating input sequences that satisfy the coverage constraints 213. An operation 305 for applying the test set 213 to the DUT 205 and an operation 307 for recording the captured outputs 217 is also provided. An operation for comparing the captured outputs 217 to the expected outputs 219 and an operation 311 for generating a report of any discrepancies from this comparison are then provided.

### Coverage Based Input Set Generation

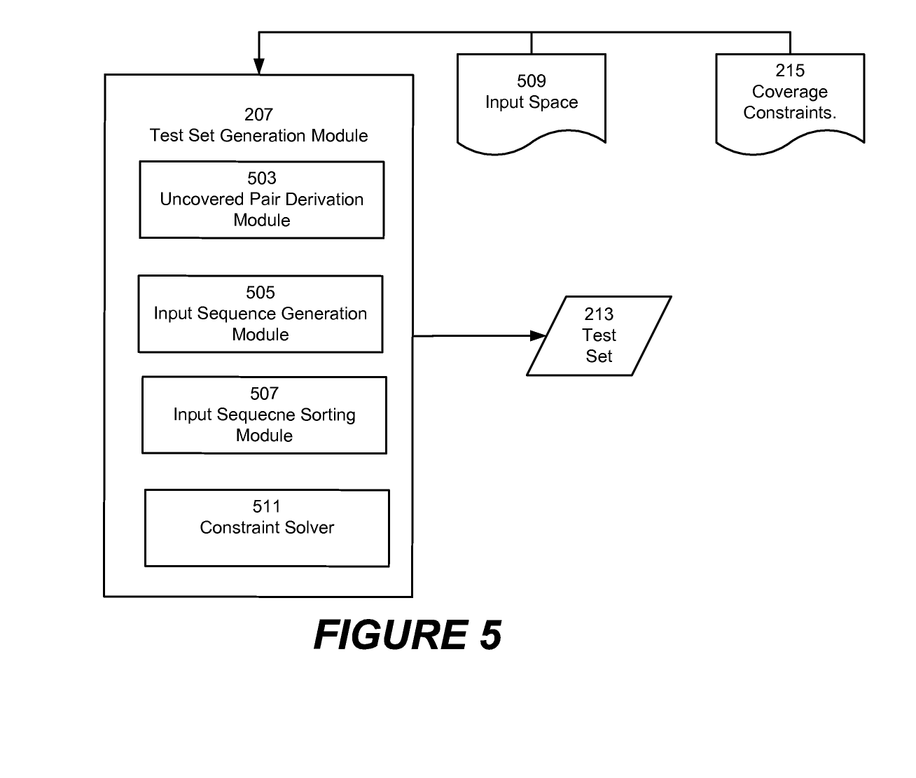

As stated, various implementations of the invention provide methods and apparatuses for generating a test set to be used for verifying an electronic design. Particularly, for generating the pairwise test set that satisfies a set of constraints. FIG. 4 shows a method 401 for generating a test set according to various implementations of the invention. FIG. 5 shows exemplary implementations of the test set generation module 207. As can be seen form FIG. 4, the method 401 includes an operation 403 for generating potential test sequences, an operation 405 for placing the uncovered sequences into an array, an operation 407 for sorting the array such that the sum of every consecutive three elements is odd. Subsequently, an operation 409 for determining if the input sequences in the array satisfy the set of constraints.

### Conclusion

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A computer-implemented method for deriving a set of input stimulus for use during verification of an electronic design, the method comprising:
identifying an electronic design to be verified;
identifying the potential inputs to the design;
identifying a set of constraints on the potential inputs;
generating a test set including input sequences using a pairwise generation technique that satisfy the set of constraints.
